(19) United States
(12) Patent Application Publication
(10) Pub. No.: US 2022/0242302 A1
(43) Pub. Date: Aug. 4, 2022

(54) Cargo Tie-Down Monitoring Device

(71) Applicant: Jason Goetz, Greenville, NY (US)

(72) Inventor: Jason Goetz, Greenville, NY (US)

(21) Appl. No.: 17/395,921

(22) Filed: Aug. 6, 2021

Related U.S. Application Data
(60) Provisional application No. 63/145,727, filed on Feb. 4, 2021.

(51) Int. Cl. B60P 7/08

(52) U.S. Cl. CPC B60P 7/0861; B60P 7/0869; B60P 7/0853

(57) ABSTRACT

The present invention relates to a cargo tie-down monitoring device for transportation vehicles. More specifically, the cargo tie-down monitoring device allows transportation vehicle operators to monitor the status of the straps, chains, cables and other cargo securing equipment in real time; thereby preventing or minimizing cargo from shifting on/or falling from a transportation vehicle. The device includes a base, fasteners, tension pressure sensors, display screen, audio and visual alarms, and a transceiver. By pairing the cargo tie-down monitoring device with an electronic device such as a cell phone, transportation vehicle operators can monitor the status of the tie-down equipment and be notified if tension or pressure changes on any of the tie-down equipment.

### CROSS-REFERENCE TO RELATED APPLICATION

The present application claims priority to, and the benefit of, U.S. Provisional Application No. 63/145,727, which was filed on Feb. 4, 2021, and is incorporated herein by reference in its entirety.

### FIELD OF THE INVENTION

The present invention relates generally to the field of cargo or load safety. More specifically, the present invention relates to a multi-purpose cargo safety device that is designed to offer real-time alerts to operators of trucks, ships, trains, planes and other transportation vehicles if cargoes or loads become unsecure, allowing the operator to take immediate action; thereby, preventing potential financial loss associated with lost cargo and; moreover, preventing potential danger of cargo falling onto roadways, other vehicles or people. The cargo safety device can easily be attached, via clamps, to conventional cargo straps currently used to secure cargo loads, and can alert operators visually, via strobe lights, and audibly. The system also has a wireless notification system that will send notifications to a user's electronic device if there is a change in the tension of a cargo strap, to help prevent loss of cargo from vehicles such as trucks, ships, trains or planes. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, various types and sizes of cargo or loads are transported from one place to another by various means of transportation such as trucks, ships, trains, planes, etc. The cargo loaded on to these means of transportation are then subjected to numerous forces from multiple directions. Accordingly, it is very important to properly secure the cargo or loads such that they do not fall or shift while being transported, as falling and shifting of cargo may cause damage to the cargo before reaching the destination, leading to financial losses. Further, cargo falling onto roadways, other vehicles or even people can be dangerous and may lead to personal injury or loss of life.

Traditionally, different types of cargo tie-downs have been used to secure cargo on to vehicles. Straps, chains, cables, and other similar devices are used to secure the load onto the load-carrying vehicles to ensure that the loaded cargo remains in place while transporting the cargo to its destination. However, the standard tie-down devices may not withstand the forces that occur during transportation, leading to the cargo shifting and possibly falling off the transport vehicle. Furthermore, if the cargo falls off the transportation vehicle, the vehicle operator may not know the cargo has fallen. Accordingly, the vehicle operator is unable to determine the cargo's status while driving the vehicle and must stop the vehicle, get out of the vehicle and then manually check the loaded cargo to determine its status. However, frequent manual checking of the cargo is inefficient, and it is impractical for a vehicle operator to frequently check the cargo while on route. Even if the operator frequently stops to check the cargo, the loaded cargo can shift or fall off the vehicle anytime between these stops. Currently, there is no means for the vehicle operators to know, continuously and in real-time, when and which cargo or load is shifting or falling. Moreover, the shifting or falling of the cargo or load can affect the vehicle's balance, and may lead to an accident of the transportation vehicle caused by an unbalanced trailer, thereby causing damage to the cargo, the vehicle, the operator and possibly other vehicles and operators. In such scenarios, this can result in loss of life to the vehicle operators and others.

Therefore, there exists a long-felt need in the art for a device that ensures cargo remains secure on transportation vehicles such as trucks, ships, trains, planes, etc. There is also a long-felt need in the art for a cargo safety device that can be easily connected to conventional cargo tie-down devices such as straps, chains, cables and other fasteners of the like. Additionally, there is a long-felt need in the art for a cargo safety device that enables the vehicle operators to know when the straps or chains tying the cargo on the vehicle are loose, and when the loaded cargo may potentially slip off the vehicle while transporting the cargo from one place to another. Moreover, there is a long-felt need in the art for a cargo safety device that does not require the vehicle operator to manually check if cargo has fallen off the vehicle. Further, there is a long-felt need in the art for a cargo safety device that ensures safe transportation of the cargo from one place to another. Furthermore, there is a long-felt need in the art for a cargo safety device that notifies the vehicle operators regarding loose cargo, and allows the vehicle operators to take immediate action to prevent the cargo from falling and causing any injuries to others. Finally, there is a long-felt need in the art for a cargo tie-down alarm system that continually monitors and notifies transportation vehicle operators when their cargo or load is or isn't secure for the safety of the vehicle operators and others.

### SUMMARY OF THE INVENTION

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cargo tie-down monitoring device that is configured to attach to a strap, chain or a cable used for securing cargo or a load on any vehicle. The cargo tie-down monitoring device provides audible and visual alarms for alerting an operator when a cargo or a load has shifted, or is unsecured. The cargo tie-down monitoring device includes a rugged base comprised of an internal battery, a controller, a plurality of strobe lights, an audio alarm, a touch screen display, a wireless transceiver and tension and pressure monitoring sensors for monitoring tension force in the tie-down to which the device is attached. Further, the base is attached to tie-down with fasteners located on opposite ends of the base. In addition, the device also generates an electrical signal when the tension force is outside of a threshold limit and the wireless transceiver transmits a notification signal to a paired electronic device of the transportation vehicle operator. The plurality of strobe lights and the audio alarm provide visual and audible alerts when the electrical signal is generated by the device. The display screen displays the tension forces sensed by the sensors of the device.

In this manner, the novel cargo tie-down monitoring device of the present invention accomplishes all of the forgoing objectives, and provides a relatively safe, easy, and efficient solution to notify transportation vehicle operators of falling or shifting cargo. Therefore, the device prevents damage and injury caused by shifting or falling cargo. The cargo tie-down monitoring device of the present invention is also user-friendly, as it does not require the vehicle operators to get out of their vehicles to manually check if the strap or cable tying down the cargo is loose or if the cargo is shifting. The cargo tie-down monitoring device further provides visual alerts using strobe lights, audio alerts using speakers and wireless notifications to the vehicle operators on paired electronic devices to ensure the vehicle operators take immediate action to prevent the shifting or falling off cargo while transporting the cargo.

In a further embodiment of the present invention, a cargo tie-down monitoring system is disclosed. The cargo tie-down monitoring system includes a cargo tie-down monitoring device coupled to an electronic device via a wireless communication channel. The cargo tie-down device includes a tension monitoring sensor to sense tension force in a load-restraining component to which the device is attached, sending real-time tension force values to the paired electronic device using a built-in wireless transceiver. The electronic device has an installed software application that also provides a user interface allowing an operator to view the tension force values. The software application further allows the operator to view a unique device ID and tension force threshold limits for the device. The software application can also be connected to a plurality of cargo tie-down monitoring devices, each device having a unique ID and tension force threshold limits, allowing an operator to view the status of multiple devices simultaneously.

In yet a further embodiment of the present invention, a method for monitoring tension force of a cargo strap is disclosed. The method includes the steps of initially attaching a tension monitoring device to a cargo strap, turning on the device either manually using touch-based display or remotely through a software application, monitoring real-time tension force value of the strap using built-in sensors of the monitoring device, setting threshold limits for the real-time tension force values of the straps, activating strobe lights on the device as a means for providing a visual alert when the tension force is outside the threshold limits, using a speaker to produce an audible sound as a means for providing an audio alert, and transmitting notification signals to a paired electronic device indicating the detected change in the tension force.

Accordingly, the monitoring device, system and method of the present invention offer a way to easily identify when and which load is may be becoming unsecured on a cargo transportation vehicle. Therefore, an operator of the vehicle need not manually check the security of the transported cargo. As a result, the operator will be continuously aware of the security of the cargo. Further, the device can be easily attached to any load-restraining mechanism such as existing cargo or load straps, chains, binders, or cables, making it extremely versatile.

To the accomplishment of the foregoing and related ends, certain illustrative aspects of the disclosed innovation are described herein in connection with the following description and the annexed drawings. These aspects are indicative; however, of but a few of the various ways in which the principles disclosed herein can be employed and are not intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the cargo strap monitoring device of the present invention in accordance with the disclosed architecture;

FIG. 2 illustrates a schematic view showing wireless communication between the cargo strap monitoring device of the present invention and an electronic device in accordance with the disclosed architecture;

FIG. 3 illustrates a perspective view showing the cargo tie-down monitoring device of the present invention strapped to a cable or strap in accordance with the disclosed architecture;

FIG. 4 illustrates a block diagram showing an exemplary user interface of a software application installed on an electronic device displaying received information from the cargo strap monitoring device of the present invention in accordance with the disclosed architecture; and

FIG. 5 illustrates a perspective view showing cargo strap monitoring devices of the present invention attached to load restraining components securing a cargo in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that ensures the cargo remains securely loaded onto vehicles such as trucks, ships, planes, etc. There is also a long-felt need in the art for a cargo safety device that can be easily connected with conventional cargo tie-down devices such as straps, chains or cables, which enables the vehicle operators to know when the tie-down devices responsible for securing the cargo on the vehicle are loose. Moreover, there is a long-felt need in the art for a cargo safety device that does not require the vehicle operator to manually check the tie-down devices to determine if any cargo has shifted on the vehicle, or if any cargo has fallen off the vehicle. Further, there is a long-felt need in the art for a cargo safety device that ensures safe transportation of the cargo from one place to another, and that immediately notifies the vehicle operators of shifting or falling cargo to allow the vehicle operator to take immediate action to prevent further movement of the cargo and subsequent loss of the cargo. Finally, there is a long-felt need in the art for a cargo tie-down alarm system that continually notifies vehicle operators of the security and safety of their cargo.

The present invention, in one exemplary embodiment, comprises a novel cargo tie-down monitoring device, system and method. The cargo tie-down monitoring system includes a cargo tie-down monitoring device coupled to an electronic smart device via a wireless communication channel. The cargo tie-down device includes a tension-monitoring sensor to sense tension force in a load-restraining component to which the device is attached, sending real-time tension force values to the paired electronic device using a built-in wireless transceiver. The electronic device has an installed software application providing a user interface for an operator to view the tension force values. The software application also allows the operator to view a unique device ID and pre-configured tension force threshold limits for the device.

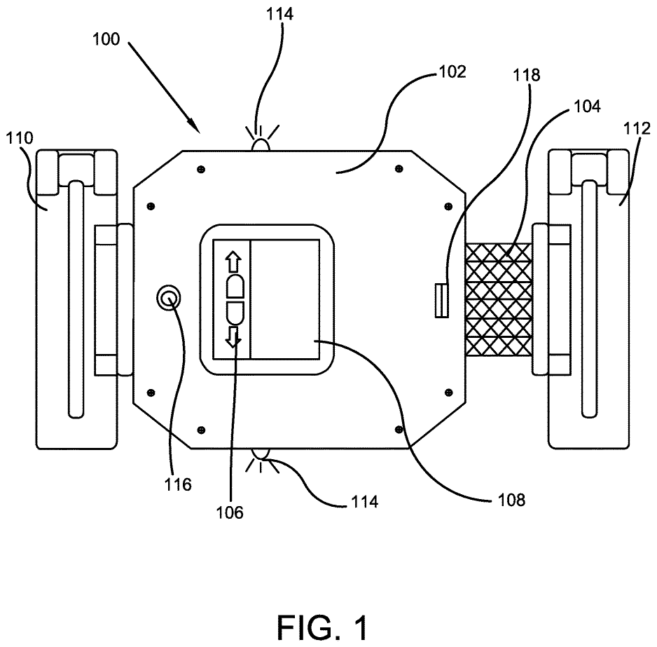

Referring initially to the drawings, FIG. 1 illustrates a perspective view of one potential embodiment of cargo strap monitoring device 100 of the present invention in accordance with the disclosed architecture. The cargo strap monitoring device 100 is configured to continuously monitor tension and pressure in a cargo/load strap, chain, binder or cable to which the device 100 is clipped/fastened. Further, the device 100 provides real-time alerts to operators of trucks, ships, planes, etc. when their cargo/load is unsecured for taking immediate action.

The cargo strap monitoring device 100 is a portable and rugged device and has fasteners to clip to different types of cargo/load straps, chains, binders or cables. The device 100 has a rugged base 102 that contains internal circuits connecting various components and sensors. The device 100 has a plurality of tension and pressure-monitoring sensors 104 in the form of a retractable ratchet strap that is positioned in a way that the sensors 104 are in physical contact with a cargo/load tie-down device, such as a strap, chain, binder or cable, to which the device 100 is clipped or fastened. The sensors 104 monitor the tension and the pressure of the strap allowing the device 100 to determine if the strap is tight or loose. The exterior surface (e.g. the surface facing away from the strap/chain/cable) of the base 102 can have a display screen 106 for showing the tension and pressure value of the attached strap, wherein the values can be displayed in digital form. Further, threshold settings can be configured for different types of straps, chains, binders, and cables. The base 102 also has a touch pad or keypad 108 allowing an operator to manually turn ON and OFF the monitoring device 100, however the device 100 can also be turned on/off via a mobile application 400. In a further embodiment, the sensors 104 may include a resistance strain gauge. The sensors 104 may monitor and collect tensioning forces, perform stress analysis, and may be used to determine if the strap is tight or loose. As known in the state of the art, the resistance of a resistance strain gauge changes when a force is applied and is converted into an electrical output signal.

To clip around a cable or any strap securing a cargo or a load, the device 100 has a magnetic or mechanical fasteners or attachments 110, 112 that can be secured to a cable or strap, allowing the device 100 to monitor the tension and pressure in the strap. The attachments 110, 112 are permanently fastened to opposite ends of the base 102 allowing the device 100 to clip to a cable or a strap such that the built-in sensor 104 touches the strap to be monitored.

The device 100 also provides real-time notifications as well as audible and visual alerts to the operator when the tension and pressure in the monitored strap is outside threshold values, indicating the device 100 has determined that the tie-down device has undergone a change in status resulting from loose or shifting cargo. The device 100 has one or more strobe LED lights 114 that illuminate to provide visual alerts 114 when the sensors 104 determines that the tie-down is loose. One or more alarms 116 also produce audio sounds to alert operators about loose cargo and load straps. The device 100 further has a USB port 118 that may contain a USB-A, USB-B, Micro-B, Micro-USB, Mini-USB, or USB-C connection that is used to charge an internal battery 212 that powers the device 100. The device 100 and all the components are also preferably waterproof and have IP66 (Ingress Protection) ratings, meaning the device 100 and all the components are rated as dust tight and protected against water.

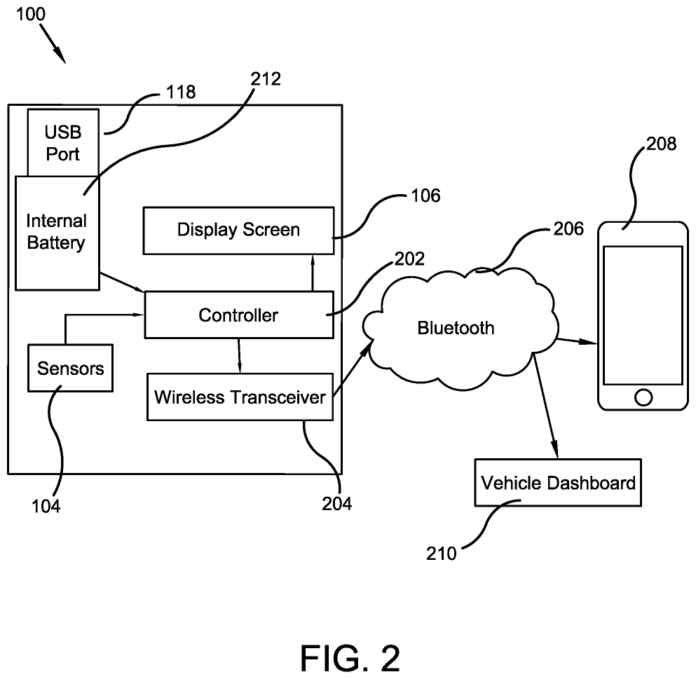

FIG. 2 illustrates a schematic view showing wireless communication between the cargo strap monitoring device 100 of the present invention and an electronic device (shown as prior art) in accordance with the disclosed architecture. As stated earlier, the device 100 has a plurality of sensors 104 that monitor the tension and pressure in a strap to which the device 100 is coupled or wrapped around. The sensors 104 generate a signal corresponding to the size of the tensioning pressure of the binding belt or strap when the tie-down device is in operation and are linked to a signal processing circuit or controller 202, wherein the display screen 106 is connected to the controller 202. The sensors 104 continuously measure and report tension and pressure values to the controller 202 such that when the controller 202 determines that the tension and pressure sensed by the sensors 104 are outside preconfigured limits, an alert signal is transmitted by the wireless transceiver 204 to a paired handheld electronic smart device 208, thereby indicating that the strap securing the cargo is loose. The built-in wireless transceiver 204 is also used by the device 100 for transmitting a wireless notification signal, wherein the transceiver 204 establishes a wireless communication channel 206 using Bluetooth or Wi-Fi to allow the signal to be sent in real-time to the electronic device 208.

It should be noted that the electronic smart device 208 can be a smartphone that is comprised of a software application. The software application includes a written program to be used on the operating system of the smartphone and allows the display screen of the smartphone 208 to display the notifications and tension values from the device 208. In a further aspect of the embodiments, the smartphone 208 stores operational software code that includes an algorithm to process the received tension and pressure information from sensors 104. Further, the device 208 can provide an audible notification to an operator in the form of a notification alert/arm. Similarly, to provide instant notifications to an operator of a transportation vehicle on which the device 100 is used, the device 100 can be paired through a wireless communication channel 206 with the wireless dashboard 210 of the vehicle. The display device of the vehicle dashboard 210 can then display notifications and can additionally produce an audible alarm to alert the operator instantly of changes in the tensions of tie-down devices. An operator can also operate the device 100 remotely using the electronic device 208 with the input given through the input device to control keypad 108 of the device 100.

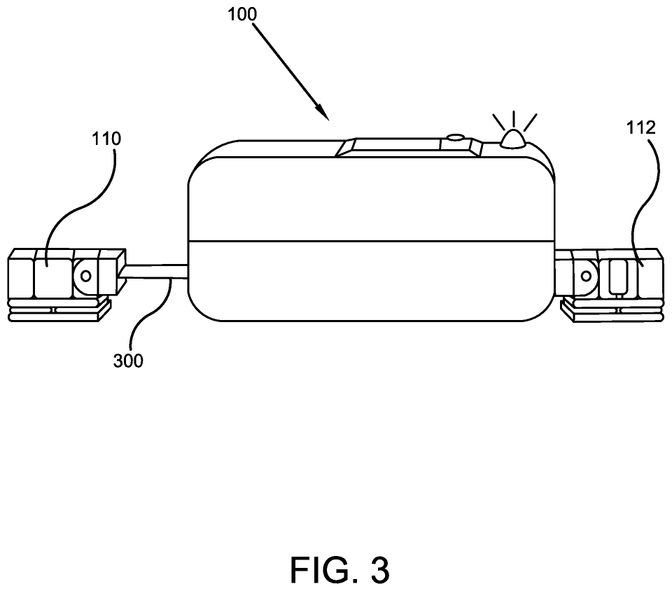

FIG. 3 illustrates a perspective view showing the cargo tie-down monitoring device 100 of the present invention strapped to a cable or strap in accordance with the disclosed architecture. The tension measuring device 100 is clipped to any strap, cable, binder, or chain using the clamp attachments 110, 112 allowing the sensors of the device 100 to measure tensioning force and pressure of the strap 300 to which the device 100 is attached. The clamps 110, 112 are secured easily by inserting the strap, cable, binder or chain into the grooves of the clamps. The clamp attachments 110, 112 can also employ any means of magnetic or mechanical attachment. The present invention can employ fasteners, hooks or clamps. Other attachment means residing within the scope of the invention can include clips, knots, bends, ties, twist-ties, clasps, grips and slots.

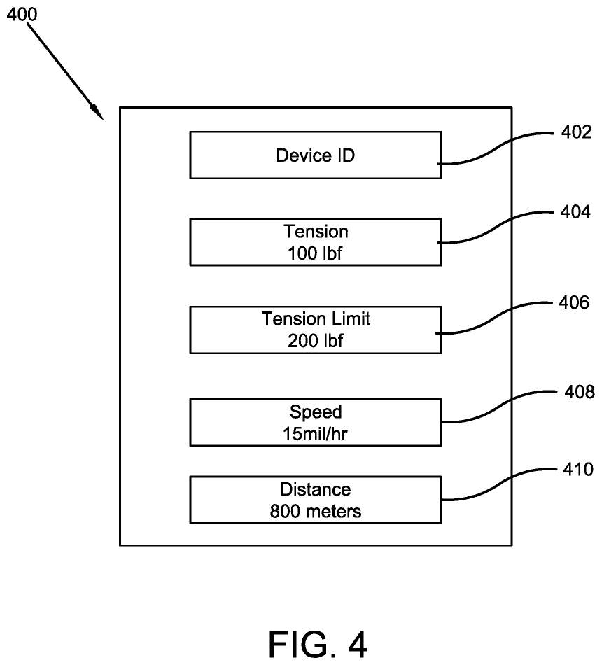

FIG. 4 illustrates a block diagram showing an exemplary user interface of software application 400 installed in an electronic device displaying received information from the cargo strap monitoring device of the present invention in accordance with the disclosed architecture. The software application 400 is used in conjunction with the device 100 of the present invention and displays information from the device 100 in real time. As shown in FIG. 4, a device ID 402 of the cargo strap device to which the application is connected is shown allowing an operator to uniquely identify the device 100. Current tension sensed by the sensors of the device 100 is shown in the tension header 404. Advantageously, a pre-configured tension limit 406 is also displayed, thereby allowing the operator to determine that a strap or the chain has lost tension and the cargo is possibly unsecured. Also, when the measured tension is less than the threshold limit 406, a visual and audible notification is received by the paired smartphone or electronic smart device. In the present embodiment, the device 100 can also have an additional sensor to measure speed of the vehicle, with threshold limits that will notify the vehicle operator when potentially dangerous speeds are attained. This allows an operator to decrease the vehicle's speed to ensure the security of the load or cargo. Accordingly, the application 400 also displays the speed 408 and the distance 410 that has been covered by the device 100 after a tension or pressure is measured to be outside of the threshold limits.

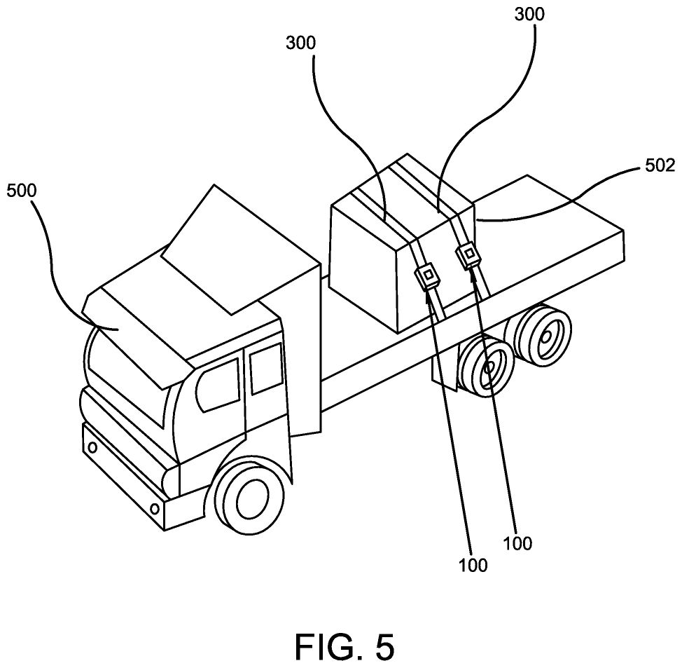

FIG. 5 illustrates a perspective view showing the cargo tie-down monitoring device 100 of the present invention attached to load-restraining components securing a cargo in accordance with the disclosed architecture. The devices 100 are clipped to the load-restraining components or tie-down devices 300 such as chains, binders, straps or cables using the clamp attachments 110, 112. The device 100 can be used with any restraining component used for securing a load or cargo 502 on a vehicle 500 such as a boat, ship, train, plane or any like vehicle 500. The built-in tension measuring sensors 104 of the device 100 measure the tension of the straps 300 and, if the measured tensions fall outside of the set threshold limits, the device 100 provides real-time notifications to an operator. Said notifications are conveyed using built-in strobe lights 114 for a visible alarm, and also an audible alarm along with notifications on the paired electronic smart device.

Using the device 100 of the present invention, the operator can continuously and clearly observe the tension force of a tie-down device making the use of the tie-down device safer and more convenient. The tensioning force can be measured and determined to be too large or too small, suggesting the binding belt status has changed. This knowledge can help guarantee the security of the cargo transported.

According to various aspects of the embodiments of the present invention, the strap tension monitoring device 100 can be operated for optimal performance while the vehicle is in motion or stationary. The sensors and associated circuitry, along with the pre-defined threshold tension value limits, result in the minimization of false signals, both false positives and false negatives. For example, the circuitry and the sensors take into consideration the environmental factors and the speed of the vehicle on which the cargo is placed to eliminate false signals.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cargo tie-down monitoring device”, “device” and “monitoring device, system, and method” are interchangeable and refer to the cargo tie-down monitoring device 100 of the present invention.

Notwithstanding the forgoing, the cargo tie-down monitoring device 100 of the present invention can be of any suitable size and configuration as is known in the art without affecting the overall concept of the invention, provided it accomplishes the above-stated objectives. One of ordinary skill in the art will appreciate that the size, configuration and material of the cargo tie-down monitoring device 100 as shown in the FIGS. are for illustrative purposes only, and that many other sizes and shapes of the cargo tie-down monitoring device 100 are well within the scope of the present disclosure. Although the dimensions of the cargo tie-down monitoring device 100 are important design parameters for user convenience, the cargo strap monitoring device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner like the term “comprising” as “comprising” is interpreted when employed as a transitional word in a claim.

What is claimed is:

1. A cargo tie-down monitoring device comprising:
a base having a pair of opposite ends;
an internal battery;
a touch screen display;
a wireless transceiver;
an audio alarm;
a plurality of strobe lights;
at least one fastener attached to each of the pair of opposite ends;
a plurality of tension and pressure sensors configured to measure a tension and a pressure of a tie-down device; and
a controller, wherein the plurality of tension and pressure sensors signal the controller when the tension or the pressure falls outside of a threshold limit, and further wherein the controller is configured to display the measured tension and pressure on the touch screen display and instruct the wireless transceiver to perform at least one of the following: (a) transmit a notification to a paired electronic device; (b) activate the audio alarm; and (c) activate the plurality of strobe lights.

2. The cargo tie-down monitoring device of claim 1 further comprised of a USB port as a means of charging the internal battery.

3. The cargo tie-down monitoring device of claim 1, wherein the at least one fastener is a mechanical fastener or a magnetic fastener.

4. The cargo tie-down monitoring device of claim 1, wherein the cargo tie-down monitoring device is waterproof.

5. A cargo tie-down monitoring system comprising:
a plurality of cargo tie-down monitoring devices each comprising a tension monitoring sensor configured to measure a tension force on a load restraining component used to secure a cargo;
a plurality of fasteners configured to attach the tension monitoring sensors to the load restraining component;
a controller;
a wireless transceiver; and
a software application on an electronic device that is in wireless communication to the plurality of cargo tie-down monitoring devices through a wireless communication channel and configured to receive a continuous signal from each of the tension monitoring sensors.

6. The cargo tie-down monitoring system of claim 5, wherein the controller is configured to allow a user to set a threshold force limit for each of the plurality of cargo tie-down monitoring devices.

7. The cargo tie-down monitoring system of claim 5 further comprising a touch screen display in communication with the controller.

8. The cargo tie-down monitoring system of claim 5 further comprising a speaker and a strobe light.

9. The cargo tie-down monitoring system of claim 8, wherein if a measured tension force falls outside the user set threshold force limit, the controller will activate the speaker and the strobe light.

10. The cargo tie-down monitoring system of claim 9, wherein if the measured tension force falls outside the user set threshold force limit, the controller will signal the wireless transceiver to send a notification to the electronic device.

11. The cargo tie-down monitoring system of claim 5, wherein the mobile application allows a user to receive and display a plurality of continuous signals from the plurality of cargo tie-down monitoring devices.

12. The cargo tie-down monitoring system of claim 5, wherein the plurality of cargo tie-down monitoring devices are waterproof.

13. The cargo tie-down monitoring system of claim 5, wherein the tension monitoring sensor is a tension strain gauge.

14. A cargo tie-down monitoring system of claim 5, wherein the plurality of cargo tie-down monitoring devices have an IP66 rating.

15. A method for monitoring a tension force on a cargo strap comprising:
attaching a tension monitoring device to the cargo strap;
turning on the tension monitoring device;
monitoring a real-time tension force value of the cargo strap using built-in sensors of the tension monitoring device;
setting a threshold force value limit for the real-time tension force values, whereby audio and visual alarms are activated if the real-time tension force values fall outside the threshold force value limit;
providing audible and visual warnings if the real-time tension force values fall outside the threshold force value limit; and
providing notification to a paired electronic device if the real-time tension force values exceed the threshold force value limit.

16. The method of monitoring tension force on a cargo strap of claim 15, wherein the built-in sensors are tension strain gauges.

17. The method of monitoring tension force on a cargo strap of claim 15, wherein the tension monitoring device is paired with an application on the electronic device having, and further wherein the application can be used to set the threshold force value limit.

18. The method of monitoring tension force on a cargo strap of claim 17, wherein the tension monitoring device can be turned on and off remotely from the application on the electronic device.

19. The method of monitoring tension force on a cargo strap of claim 17, wherein the tension monitoring device is further comprised of a plurality of tension monitoring devices attached to a plurality of cargo straps.

20. The method of monitoring tension force on a cargo strap of claim 17, wherein the application on the electronic device can be used to turn on and off each of the plurality of tension monitoring devices.
